(19) United States
(12) Patent Application Publication
(10) Pub. No.: US 2021/0224414 A1
(43) Pub. Date: Jul. 22, 2021

(54) Discovery and Production of Electronically Stored Information

(71) Applicant: Granite Legal Systems, Inc., Houston, TX (US)

(72) Inventors: Jeffrey R. Hewett, Houston, TX (US); D. Shawn Edwards, Missouri City, TX (US); Michael B. Voran, Kirkland, WA (US); Micheal S. Hewett, Cameron Park, CA (US)

(73) Assignee: Granite Legal Systems, Inc., Houston, TX (US)

(21) Appl. No.: 16/746,820

(22) Filed: Jan. 18, 2020

(51) Int. Cl. G06F 21/62; G06F 16/25; G06Q 50/18

(52) U.S. Cl. CPC G06F 21/6245; G06Q 50/18; G06F 16/252; G06F 16/258

(57) ABSTRACT

Provided are techniques for the collection and production of structured electronic data in a judicial setting. The disclosed technology provides a rapid, cost-efficient system for discrete record based ingestion, review and production. Collected information is stored, analyzed, filtered and indexed, all while adhering to strict document preservation and chain of custody requirements. Filtering can be based upon such criteria as record field type, date range, key word searches and individual or group custodial selection. In addition, interfaces and processes for redaction and production delivery format generation for use within the judicial setting are provided. Individual fields within records within collected data sets may be identified for review, applying production disposition criteria, selective redactions and decision justification documentation. Additionally, the techniques provide means to revise, update and reverse modifications to the data set as required by the discovery process.

### FIELD OF THE DISCLOSURE

The claimed subject matter relates generally to techniques for collection. discovery and production of electronically stored information (PSI) in enterprise data systems.

### BACKGROUND

E-mail, word processing documents, spreadsheets and other unstructured data are the typical focus in the discovery of electronically stored information (ESI) within a legal setting. Highly publicized, landmark cases ensure that no one forgets to examine back up tapes and archives as well. Yet One often-overlooked source of ESI presents unique challenges to a ligation team: enterprise database systems (EDSs). Not only is the information stored in enterprise data systems frequently relevant and discoverable, that information usually represents high value data that is key to the core litigation issues. The discovery process tor enterprise data systems, however, involves significant challenges that require expert technical assistance to avoid errors, reduce costs and assure defensibility.

Organizations use enterprise data systems to capture, store and transform data for core business functions such as finance, regulatory compliance, manufacturing, sales and human resource functions. Distinct from common electronic files such as Microsoft. Office documents or e-mail repositories that individuals choose and determine how to organize in a personalized—unstructured—manner, data contained within an enterprise system will share a common organization regulated through the specific system interface. This standardized organizational data form—structured data has different discovery planning, collection and processing, requirements from the familiar loose electronic files and messaging data that the legal industry has successfully managed in the past.

The foundation of many enterprise data systems are database management systems (DBMSs) such as Oracle, SAS, SQL, IBM DB2, SAP and Lotus Notes/Domino, all of which may be differently structured. Differently structured DBMSs may have, for example but not limited to, different field, table, storage and metadata standards. An end user performs a series of steps to enter or retrieve information. The output may be a screen display of information, a decision tree or outcome such as a document, report or export of raw data used to manage the business. Examples may include manufacturing history tracking, claim or complaint management systems and inventory tracking software. In general, an organizational need to manage large volume transactions or business process steps will likely result in an enterprise system implementation.

### SUMMARY

Provided are techniques for a disciplined, methodical and legally defensible approach for the efficient and accurate identification, collection, analysis, review and production of enterprise data. As the inventors herein have realized, enterprise data systems do not fit within the established discovery processes for emails, traditional loose files and other such “unstructured data”. The identification, collection, analysis, review and production of the ESI from enterprise data systems is complex due to numerous factors, including but not limited to:
Capacity: By definition, these systems store vast amounts of information. Enterprise system transactional data sets for a mid-sized company will commonly contain hundreds of millions of records or more stored as terabytes of data. (This is not “big data.”)
Diversity: Each system is highly customized for the unique needs of each organization Even systems with the same marketing name (i.e., SAP, PeopleSoft, JDE) are rarely structured the same way, requiring customer and system specific discovery solutions.
Complexity: Responsive data identification requires an understanding of the system's internal structure, relationships and connections to other systems that may span organizational business units. Incomplete data identification can hinder a complete organizational data view.
Functionality: Corporations design systems to meet business needs, not with litigation in mind. As a result, they usually have no “easy button” for the transformation of data into a format suitable for review and production in litigation.
Sensitivity: Clients have a legal or business obligation to protect private and sensitive information, including employee data, customer information, financial records, health records and credit card numbers contained within the corporate systems.
Usability: Discovery team must be prepared to convert data received from enterprise data systems into a format suitable for attorney review, analysis and production. Specific resource skill sets and took are required for translating litigation requirements into technical specifications for identification, collection, analysis, review and production of ESI from enterprise data systems.

Discovery is a system and method for the collection and production of documents in a judicial setting, i.e., a judicial production request.” In judicial litigation, document production is a time-consuming and expensive necessity. Because the United States judicial system operates on the principle that justice is best served when parties have access to as many of the relevant facts as possible, each party is typically required by law to make relevant materials available to other parties. Procedural rules, both state and Federal, mandate the manner in which this process, or “document production,” is conducted. It should be noted that the term “document production” does not imply the creation of documents but rather such activities as, but not limited to, the collection, filtering and transmitting of documents to different parties within a legal, or judicial, setting. Rules relating to document production specify such requirements as, but not limited to, the types of material subject to disclosure, where or not any particular material is protected by privilege and custodial and notice requirements.

This summary is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed description.

### BRIEF DESCRIPTIONS OF THE DRAWINGS

A better understanding of the claimed subject matter can be obtained when the Hallowing detailed description of the disclosed embodiments is considered in conjunction with the following figures.

FIG. 1 is a block diagram of a computing system architecture employed as one example of an environment in which the claimed subject matter may be deployed.

FIG. 2 is a block diagram of a second possible computing system architecture in which the claimed subject matter may be deployed.

FIG. 3 is a flowchart of a Data Production process that incorporates the claimed subject matter.

FIG. 4 is a flowchart of a Staging process that implements a portion of the data production process of FIG. 3.

FIG. 5 is a flowchart of a Project Setup process that implements a portion of the data production process of FIG. 3.

FIG. 6 is a flowchart of a Ingestion process that implements a portion of the data production process of FIG. 3.

FIG. 7 is a flowchart of a Performance process that implements a portion of the data production process of FIG. 3.

FIG. 8 is a flowchart of a Deliverable Generation process that implements a portion of the data production process of FIG. 3.

FIG. 9 is a flowchart of a Project Termination process that implements a portion of the data production process of FIG. 3.

FIG. 10 is an illustration of Batch Redaction Window that enables a user to implement the functionality of the claimed subject matter.

FIG. 11 is an illustration of the Batch Redaction Window of FIG. 10 showing some additional functionality of the claimed subject matter.

### DETAIL DESCRIPTION

Although described with particular reference to document production in a judicial setting, the claimed subject matter can be implemented in any information technology (IT) system in which analysis of information stored in electronic databases is desired. Those with skill in the computing arts Will recognize that the disclosed embodiments have relevance to a wide variety of computing environments in addition to those described below. In addition, the methods of the disclosed technology can be implemented in software, hardware, or a combination of software and hardware. The hardware portion can be implemented using specialized logic; the software portion can be stored in a memory and executed by a suitable instruction execution system such as a microprocessor, personal computer (PC) or mainframe.

In the context of this document, a “memory” or “recording medium” can be any physical means that contains, stores, communicates, propagates, or transports the program and/or data for use by or in conjunction with an instruction execution system, apparatus or device. Memory and recording medium can be, but are not limited to, an electronic, magnetic, optical, electromagnetic or semiconductor system, apparatus or device. Memory and recording medium also includes, but is not limited to, for example the following: a portable computer diskette, a random access memory (RAM), a read-only memory (ROM), an erasable programmable read-only memory (EPROM or flash memory), and a portable compact disk read-only memory or another suitable medium upon which a program and/or data may be stored.

One embodiment, in accordance with the claimed subject, is directed to a programmed method for document collection and production. The term “programmed method”, as used herein, is defined to mean one or more process steps that are presently performed; or, alternatively, one or more process steps that are enabled to be performed at a future point in time. The term programmed method anticipates three alternative forms. First, a programmed method comprises presently performed process steps. Second, a programmed method comprises a computer-readable medium embodying computer instructions, which when executed by a computer performs one or more process steps. Finally, a programmed method comprises a computer system that has been programmed by software, hardware, firmware, or any combination thereof, to perform one or more process steps. It is to be understood that the term “programmed method” is not to be construed as simultaneously having more than one alternative form, but rather is to be construed in the truest sense of an alternative form wherein, at any given point in time, only one of the plurality of alternative forms is present.

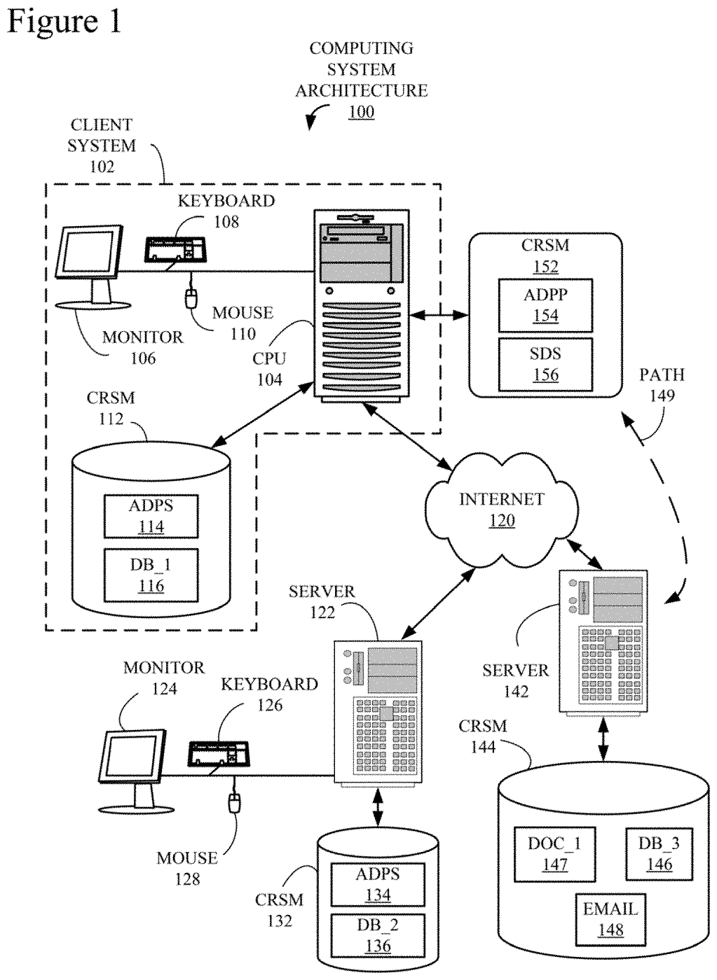

Turning now to the figures, FIG. 1 is a block diagram of a computing system architecture 100 employed as one example of an environment in which the claimed subject matter may be deployed. A client system 102 includes a central processing unit (CPU) 104, coupled to a monitor 106, a keyboard 108 and a pointing device, or “mouse” 110, which together facilitate human interaction with computing system 100 and client system 102. Also included in client system 102 and attached to CPU 104 is a computer-readable storage medium (CRSM) 112, which may either be incorporated into CPU 104 i.e. an internal device, or attached externally to CPU 104 by means of various, commonly available connection devices such as but not limited to, a universal serial bus (USB) port (not shown).

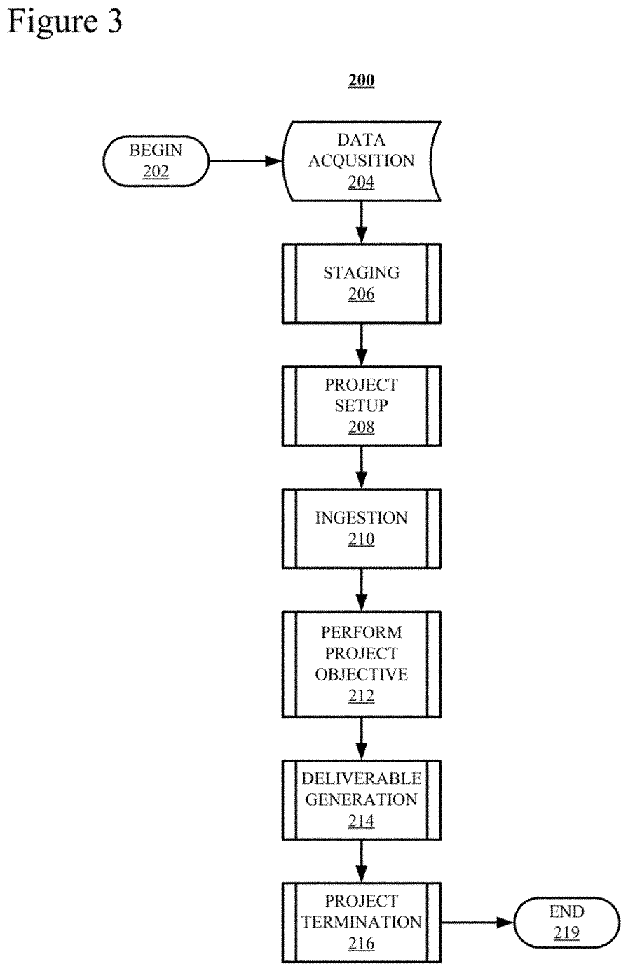

CRSM 112 is illustrated storing an Automatic Database Production Server (ADPS), i.e. an ADPS 114, and a database, i.e., a DB_1 116. ADPS 114 is explained in detail below in conjunction with FIGS. 3-11. Client system 102 and CPU 104 are connected to the Internet 120, which is also connected to a server computer 122 and a server computer 142. Like client system 102, server 122 is coupled to a monitor 124, a keyboard 126 and a mouse 128, which together facilitate human interaction with server 122. Also coupled to server 122 is a CRSM 132, which is illustrated as staring an Automatic Database Production Server (ADPS), i.e. an ADPS 134, and a database, i.e., a DB_2 136. ADPS 134 is described in more detail below in conjunction with FIGS. 3-11. ADPS 134 is configured to enable document and data collection in accordance with the claimed subject matter from any network accessible location, such as server 142. Although not shown, server 142 would also typically have a monitor, keyboard and mouse like devices 106, 108 and 110. Server 142 is coupled to CRSM 144 that includes a database (DB_3) 146, a collection of documents, or Doc_1 147 and a collection of email documents, or Email 148. Throughout this Specification, DB_3 146, Doc_1 147 and Email 148 are employed as examples of information that might be subject to a judicial request for information. As the inventors herein have realized, although document. production with respect to legal matters is typically directed to documents and emails, such as Doc_1 147 and Email 148, databases such as DB_3 146 also include important information that is typically overlooked using currently available procedures. It should also be noted that a typical computing system such as system 142 would typically store many more documents and might include multiple databases and email repositories. For the sake Of simplicity only one example of each is shown.

Although in this example, client system 102, server 122 and server 132 are communicatively coupled via the Internet 120, they could also be coupled through any number of communication mediums such as, but not limited to, a local area network (LAN) (not shown). It should also be understood that data and process storage and implementation is not limited to the use of CRSMs but may also include “cloud” and any other current and yet to be developed data and process storage and implementation systems. Further, it should be noted there are many possible computing system configurations, of which computing system 100 is only one simple example.

FIG. 1 also illustrates a CRSM 152 that includes a portable component of the claimed subject matter, i.e. an ADPP 154. In this example, CRSM 152 is a portable USB drive that is illustrated connected to client system 102 via a USB plug (not shown). Of course, CRSM 152 may be configured to attach to a computing system via any available communication port or even be configured to be plugged into a network hub so that the claimed subject matter may be implemented simultaneously on several computing systems.

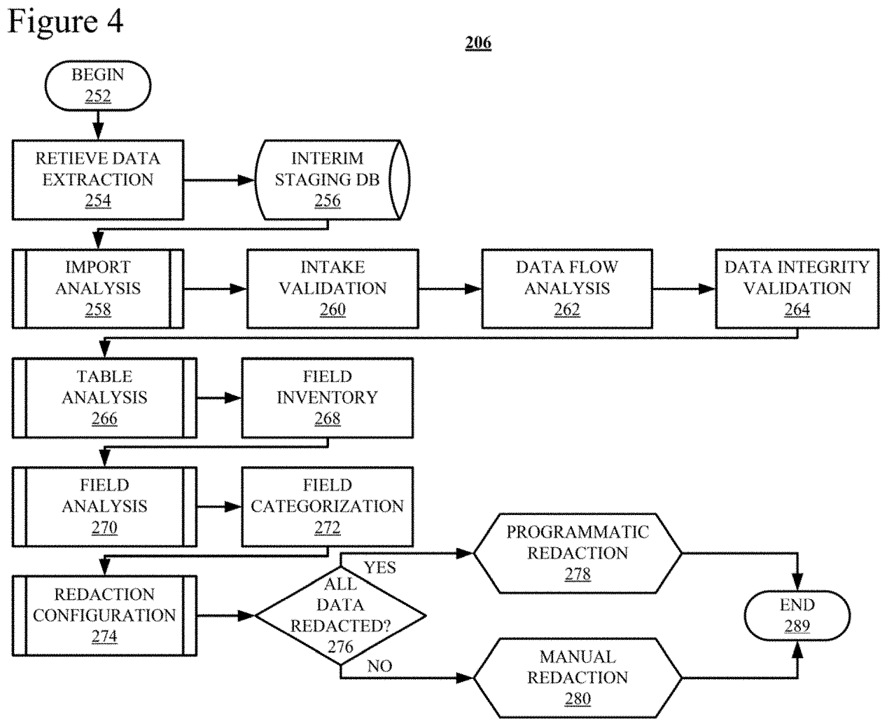

CRSM 152 also includes a standardized directory structure (SDS) 156 to place collected files, metadata and collection event information. Collection event information includes information such as, but not limited to, the history of collection processes, who collected files, for whom files were collected and process start and ending times. In this example, information stored in SDS 156 is stored in eXtensible Markup Language (XML) files when returned to ADPS 114 in a Staging process 206 (see FIG. 4).

To enable a user with access to documents and data subject to production, or a “custodian,” to collect files such as those represented by Doc_1 147, Email 148 and data stored in DB_3 146, CRSM 152 is configured as a mapped drive for ADPP 154. In this example, ADPP 154 is an applet configured to execute on CPU 104 and have access to Internet 120 via client system 102. However, access to Internet 120 is not required and an alternative path 149 for transporting collected materials is illustrated. Path 149 represents methods of transferring data stored on CRSM 144 to a server such as server 122 and may be, but is not limited to, merely unplugging CRSM 152 from client system 102 and plugging it into server 122.

ADPS 114, ADPS 134 and ADPP 154 work together to enable remote data set aggregation. ADPS 134 enables a single server such as server 122 to support both local and remote data collection activities, eliminating the need for server implementations at multiple sites, some of which may have either one or few individual computers. A remote data capture by ADPP 154 on CRSM 152 and subsequent aggregation integrates remote file collections into a central repository by means or a collection queuing and monitoring process. A resulting file collection, which includes file metadata and other information, is indistinguishable from a data collection created by ADPS 134 alone, resulting in a single, integrated project repository. Processes associated with the collection, aggregation and processing of files associated with a project are described in more detail below in conjunction with FIGS. 3-11.

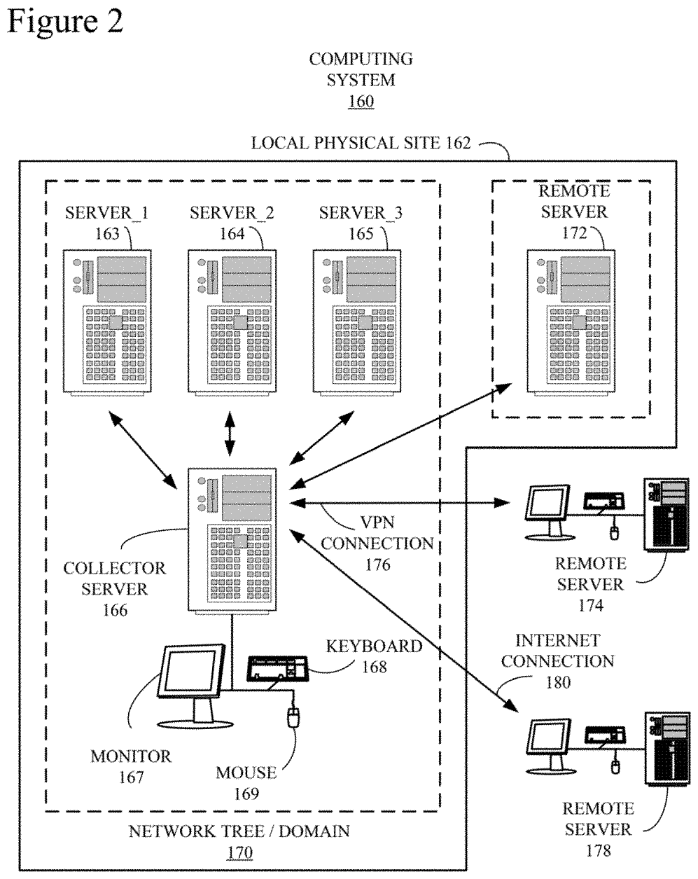

FIG. 2 is a block diagram of a second possible computing system architecture 160 in which the claimed subject matter may be deployed. Computing system 160 shows a local physical site 162 that includes a server_1 163, a server_2 164, a server_3 165 and a collection server 166. Servers 163-166 would typically be connected via a local area network (LAN) not shown). Collector server 166 is illustrated with a monitor 167, a keyboard 168 and a mouse 169 to enable human interaction with collection server 166 as well as servers 163-165. Although not shown, server 166 includes an ADPS such as ADPS 134 (FIG. 1). A remote server 172 is coupled to servers 163-166 and local physical site 162 in network tree, or “domain,” 170. One possible implementation of domain 170 is as a wide area network (WAN).

Also illustrated are a remote server 174, which is coupled to local physical site 162 and domain 170 via a virtual private network (VPN) connection 176, and a remote server 178, which is coupled to local physical site 162 and domain 170 via an Internet connection 180. The disclosed techniques may be employed over VPN connection 176 such that custodians experience the same functionality as users on servers 163-166 and 172. Over Internet connection 180, the disclosed techniques support data collection from a client application such as ADPS 114 (FIG. 1). Those with skill in the computing and communication arts should appreciate that computing system 160 is just one example of a computing architecture and that there are many configurations and communication techniques that could be employed to implement the claimed subject matter.

One implementation of the claimed subject matter provided server-to-server (S2S) transmission of collected files. For example, a user on collector server 166 may execute an instantiation of ADPS 134 to retrieve materials from remote server 172. If a destination database is on remote server 174, a list of files to be collected may be transmitted to server 166 rather than the actual files. Then, server 174, rather than server 166, schedules and executes the transmission of the actual files from server 174 to server 166. There are at least three advantages to this approach: 1) files may be transmitted faster between remote server 174 and server 166 by removing server 166 from the transmission process; 2) an administrator is able to more efficiently manage server utilization; and 3) an administrator is able to more efficiently manage communication bandwidth resources. Collection queuing and monitoring functions are described in more detail below in conjunction with FIGS. 3-11.

FIG. 3 is a flowchart of a Data Production process 200 that incorporates the claimed subject matter. Process 200 starts in a “Begin” block 202 and proceeds immediately to a “Data Acquisition” block 204. In the following examples, logic associated with process 200 is stored on CRSMs 112 and 132 (FIG. 1) and executed by processors associated with client system 102 and server 122 (FIG. 1).

During processing associated with “Data Acquisition” block 204, data stored in a selected database, in this example. DB_3 146, is gathered for analysis in accordance with the claimed subject matter. During processing associated with a “Staging” block 206, the data collected during processing associated with block 204 is analyzed to determine the scope of the job and to determine the structure in which the data has been stored within DB_3 146. Block 206 is described in more detail below in in conjunction with FIG. 4.

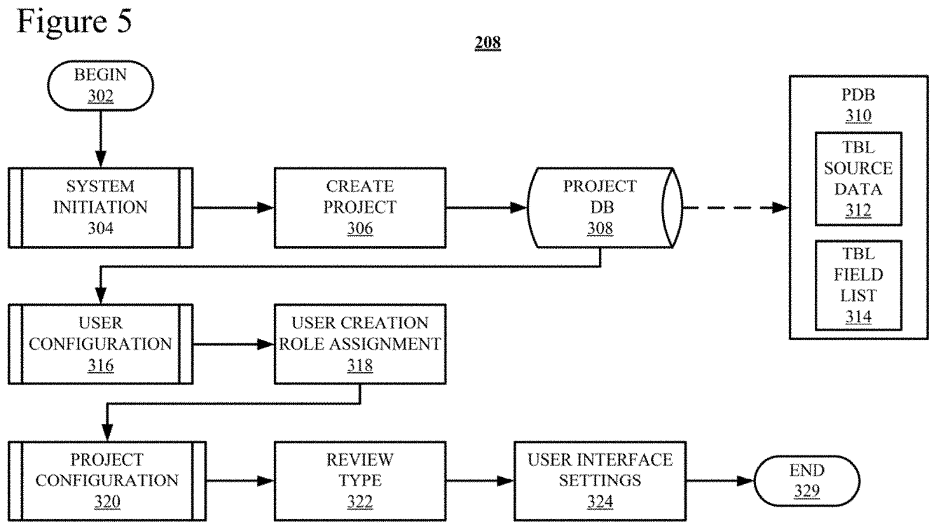

During processing associated with a “Project Setup” block 208, the analysis conducted during processing associated with block 206, is employed to generate a structure for the storing and analysis of the data. Block 208 is described in more detail below in in conjunction with a “Project Setup” process 300 (see FIG. 5).

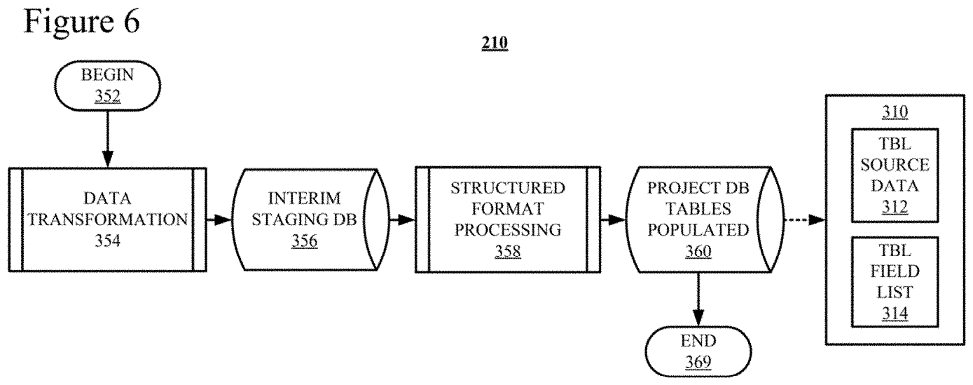

During processing associated with an “Ingestion” block 210, the data collected during processing associated with block 204 is inserted into the structure generated during processing associated with block 208. Block 210 is described in more detail below in in conjunction with an “Ingestion” process 350 (see FIG. 6).

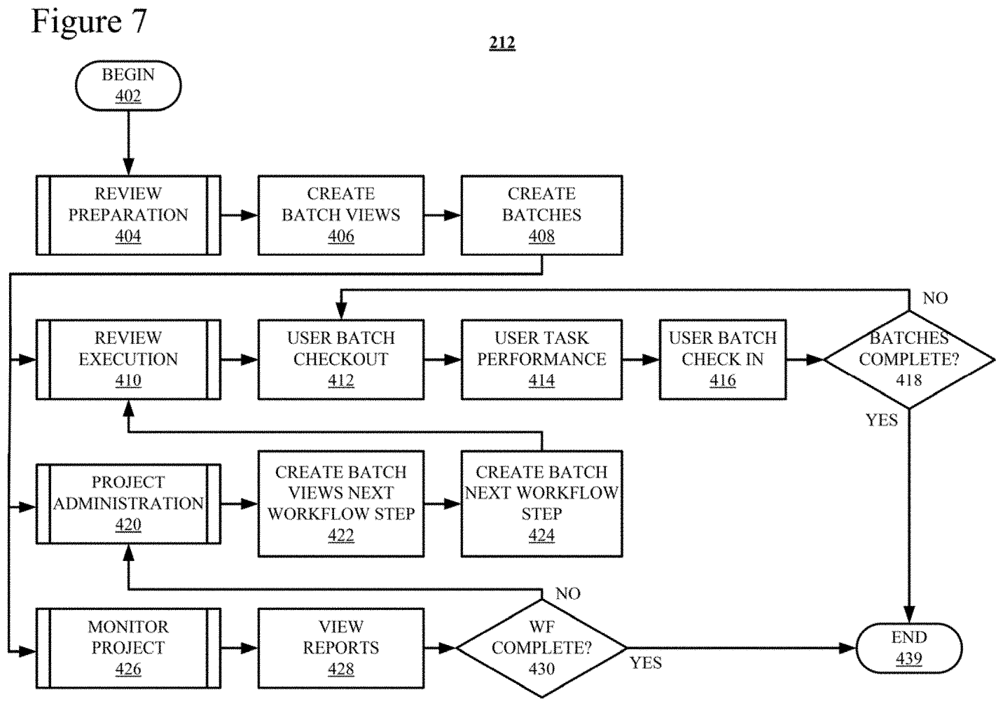

During processing associated with a “Perform Object Objective” block 212, the data inserted during processing associated with block 210 is manipulated to separate the data into “batches” to facilitate further processing. In addition, summary and detailed management reports are generated based upon that processing. Block 212 is described in more detail below in in conjunction with a “Perform Object Objective” process 400 (see FIG. 7).

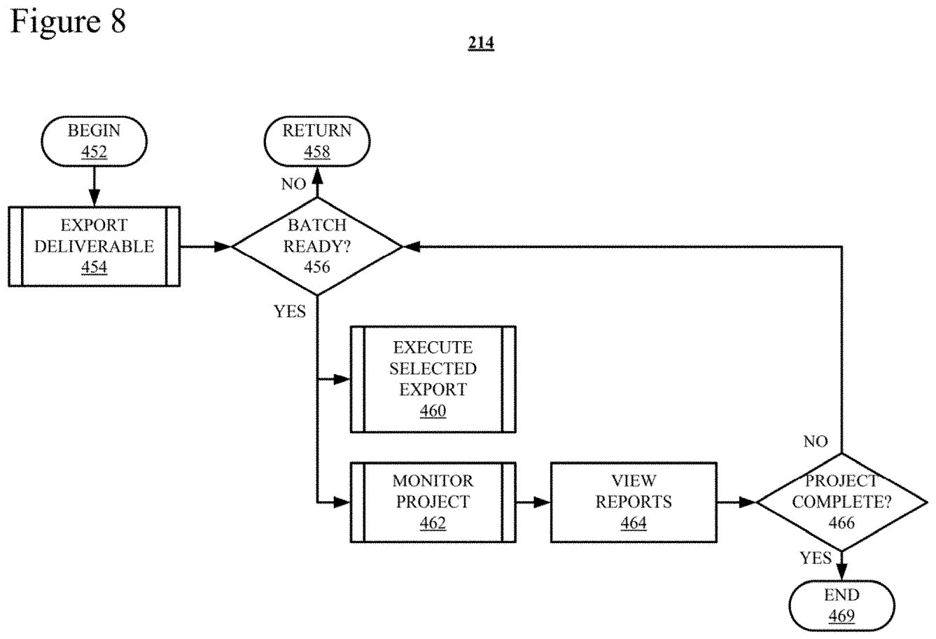

During processing associated with a “Deliverable Generation” block 214, processed batches of data and the reports generated during processing associated with block 212 are viewed and monitored for acceptability and completeness. Block 214 is described in more detail below in in conjunction with a “Deliverable Generation” process 450 (see FIG. 8).

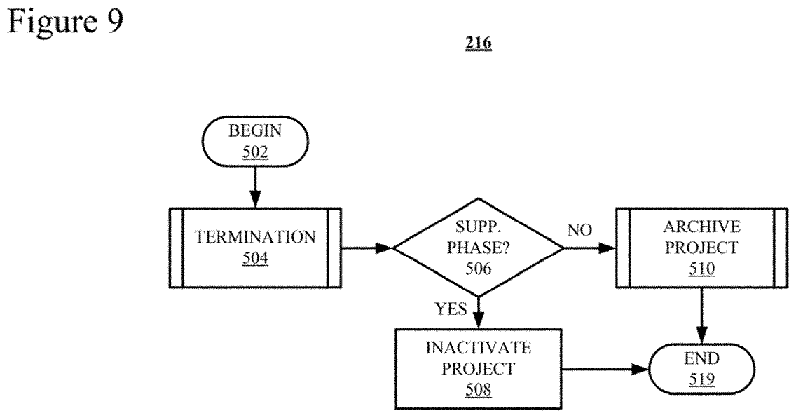

During processing associated with a “Project Termination” block 216, the project established during processing associated with block 208 is completed. Block 216 is described in more detail below in in conjunction with FIG. 9. Finally, during processing associated with an “End” block 219, process 200 is complete.

FIG. 4 is a flowchart of Staging process 206, first introduced above in conjunction with FIG. 3. Process 206 starts in a “Begin” block 252 and proceeds immediately to a “Retrieve Data Extraction” block 254. During processing associated with block 254, the data gathered during processing associated with block 204 (FIG. 3) is retrieved and stored in a temporary database during processing associated with an “Interim Staging DB” block 256.

During processing associated with an “Import Analysis” block 258, an “Intake Validation” block 260, a “Data Flow Analysis” block 262 and a “Data Integrity Validation” block 264, the data retrieved during processing associated with block 254 is checked to ensure that it is valid, complete, that the structure and relationship among data elements is correct and that the data collection process itself was performed correctly.

During processing associated with a “Table Analysis” block 266, the table schema of the retrieved data is examined and analyzed. During processing associated with a “Field Inventory” block 268, the type and number of fields within the tables examined during processing associated with block 266 is determined. During processing associated with a “Field Analysis” block 270, the actual data with the fields is examined. During processing associated With a “Field Categorization” block 272, the information gathered during processing associated with block blocks 266, 268 and 270 is analyzed to determine the particular fields to be redacted.

During processing associated with a “Redaction Configuration” block 274, a redaction policy is established. During processing associated with an “All Data Redacted?” block 276, a determination is made as to whether or not, with respect to any particular field, all the data or merely selected portions require redaction. If all fields require redaction, control proceeds to a “Programmatic Redaction” block 278. During, processing associated with block 278, the required redaction is performed automatically. If a total field redaction is not indicated during processing associated with block 276, control proceeds to a “Manual Redaction” block 280 during which an administrator or other user performs the redaction manually. Finally, following both blocks 278 and 280, control proceeds to an “End” block 289 in which process 206 is complete.

FIG. 5 is a flowchart of a Project Setup process 208, first introduced above in conjunction with FIG. 3. Process 208 starts in a “Begin” block 302 and proceeds immediately to a “System Initiation” block 304. During processing associated with block 304, configuration parameters are loaded for processing. During processing associated with a “Create Project” block 306, a database for processing the data retrieved during processing associated with block 254 (FIG. 4) is established, including identification of the client, users and administrators. In addition, a project database, in this example PDB 310, is established during processing associated with a “Project DB” block 308. PDB 310 includes a Table (Tbl) source data 312 and Tbl field list 314. PDB 310 represents a “normalization” of the different types of databases and their respective data schemas that might be encountered not only across different organizations but also even within a single organization. Those with skill in the relevant arts will understand processes that may be involved in “normalization.” One example of normalization would be, but is not limited to, an automated process to transform different row based or other data storage formats to a common column based format such that two or more differently structured databased may be stored in a single data structure. In other words, it is desirable to generate a single data repository for efficient attorney review and judicial production requests. In this manner, the data may be formatted into a format suitable for attorney review with respect to a judicial production request, compliant with established legal review team processes, grouping data elements for attorney review and structuring group data delivery for initial review, quality control and production phases.

During processing associated with an “User Configuration” block 316, the users, or people responsible for performing the project objectives, are identified. The product of block 316 is an “User Creation Role Assignment” data 318 that specifies the respective roles of users identified during processing associated with block 316, roles that may include, but are not limited to, reviewer, quality control and administrator. During processing associated with a “Project Configuration” block 329, parameters are set to control the operation of the discovery process, including a “Review Type” block 322 and “User Interface Settings” 324. Finally, control proceeds to a “End” block 329 in which process 208 is complete.

FIG. 6 is a flowchart of a Ingestion process 210, first introduced above in conjunction with FIG. 3. Process 210 starts in a “Begin” block 352 and proceeds immediately to a “Data Transformation” block 354 in which the data retrieved during processing associated with block 254 is stored in a temporary database, such as DB_2 136 (FIG. 1), corresponding to an “Interim Staging DB” block 356.

During processing associated with a “Structured Format Processing” block 358, the data stored during processing associated with block 354 is converted from the format in which it was retrieved into a format corresponding to PDB 310 (FIG. 5).) In other words, the data is subject to normalization, or “normalized,” by the conversion of data in each of differently structured DBMSs into a single structure so that different types of databases and their respective data schemas, not only across different organizations but also even within a single organization, may all be processed in the same manner. During processing associated with a “Project DB Table Populated” block 360, the data convened during processing associated with block 358 is inserted, in the new format, into PDB 310. Finally, control proceeds to an “End” block 369 in which process 210 is complete.

FIG. 7 is a flowchart of Perform Project Objective process 212, first introduced above in conjunction with FIG. 3. Process 212 starts in a “Begin” block 402 and proceeds immediately to a “Review Preparation” block 404. During processing associated with block 404, the database creation and preparation associated with block 306 (FIG. 5) is checked to ensure that the project may proceed. During processing associated with a “Create Batch Views” block 406, the data stored in PDB 310 (FIGS. 5&6) is organized into smaller units, or “batches,” such that each batch is an appropriate size for a single reviewer to view in a reasonable amount of time. Organizing the data into batches ensures that the project process may be performed by multiple users without any unnecessary duplication of effort and that all the data can be processed. During processing associated with a “Create Batches” block 408, the data organized during processing associated with block 406 is actually partitioned for delivery to the users that will perform the data review. After processing of block 498, control proceeds in parallel to a “Review Execution” block 410, a “Project Administration” block 420 and a “Monitor Project” block 426.

During processing associated with a “Review Execution” block 410, the partitioned batches are each allocated to the appropriate users, or reviewers. During processing associated with an “User Batch Checkout” block 412, each reviewer checks out an assigned batch from PDB 310 and, during processing associated with a “User Task Performance” block 414. the reviewer processes the checked-out batch. Once a batch has been reviewed, the reviewer checks in the assigned batch during processing associated with an “User Batch Check In” block 416. During processing associated with a “Batches Complete?” block 418, a determination is made as to whether or not all batches have been reviewed. If not, control returns to User Batch Checkout block 412, the reviewer checks out another unprocessed batch and processing continues as described above.

During processing associated with Project Administration block 420, administrators monitor the batch activities corresponding to blocks 410, 412, 414, 416 and 418. During processing associated with a “Create Batch Views Next Workflow Step” block 422, administrators may create new batch views as in block 406 and, during processing associated with a “Create Batch Next Workflow Step” block 424, create new batches as in block 408. Once new batch views and batches have been generated, control returns to Review Execution block 410 and processing continues as described above with respect to the new views and batches.

During processing associated with “Monitor Project” block 426, administrators monitor the process by viewing generated reports during processing associated with a “View Reports” block 428. During processing associated with a “Workflow (WF) Complete?” block 430, a determination is made as to whether or not all batches have been processed. In not, control returns to Project Administration block 420 and processing continues as described above.

If a determination is made the all batches have been processed during processing associated with blocks 418 or 430, control proceeds to an End” block 439 in which process 212 is complete.

FIG. 8 is a flowchart of Deliverable Generation process 214, first introduced above in conjunction with FIG. 3. Process 214 starts in a “Begin” block 452 and proceeds immediately to a “Export Deliverable” block 454. During processing associated with block 454, batches processed in accordance with process 212 (FIG. 7) are exported for review. During processing associated with a “Batch Ready?” block 456, a determination is made as to whether or not a particular batch is ready to be delivered. In not, control proceeds to a “Return” block 458 and control returns to process 212 for further processing. If a determination is made that a batch is ready for export, control proceeds to an “Execute Selected Export” block 460. During processing associated with block 460, the batch that has been determined to be ready for export is transmitted to the appropriate party. Concurrently, control also proceeds to a “Monitor Project” block 462, during which administrators analyze the results of process 200 (FIG. 3) so far. Control then proceeds to a “View Reports” block 464, during which the reports generated by the review of the batches are analyzed. During processing associated with block a “Project Complete?” block 466, a determination is made as to whether or not the project represented by process 200 has been satisfactorily completed. If not, control returns to Batch Ready 456 and processing continues as described above. If so, control proceeds to an “End” block 469 in which process 214 is complete.

FIG. 9 is a flowchart of a Project Termination process 216, first introduced above in conjunction with FIG. 3. Process 216 starts in a “Begin” block 502 and proceeds immediately to a “Termination” block 504. During processing associated with block 504, steps are taken to conclude process 200 (FIG. 3). During processing associated with a “Supplemental (Supp.) Phase?” block 506, a determination is made as to whether or not additional processing may be necessary. If so, control proceeds to an “Inactivate Project” block 508 during which the current project is inactivated while additional, or supplemental, processing is performed. If not, the results of process 200 are stored during processing associated with an “Archive Project” block 510. Once process 216 has been inactivated or archived, control proceeds to an “End” block 519 in which process 216 is complete.

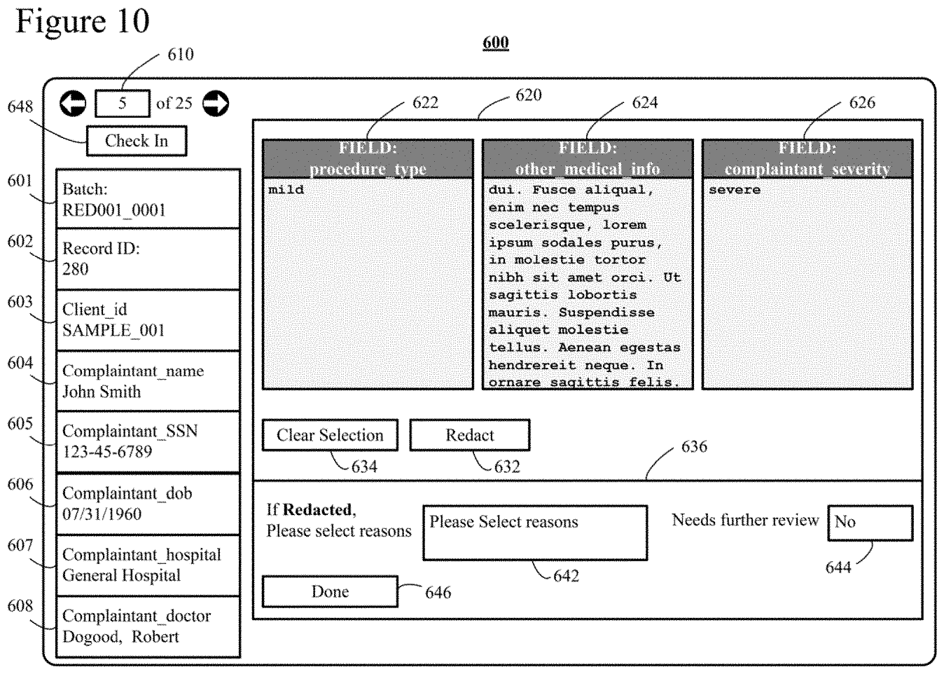

FIG. 10 is an illustration of Batch Redaction Window 600 that enables a user to implement functionality of the claimed subject matter. In this example, Window 600 would be displayed on monitor 106 by logic stored on CRSM 112 in conjunction with ADPS 114 and executed with processors not shown) of Client System 102, all described above in conjunction with FIG. 1. In general, FIG. 10 shows a computer window intended to facilitate a manual redaction of database records (see 280, FIG. 4) that are being handled in “batches” (see 212, FIG. 7).

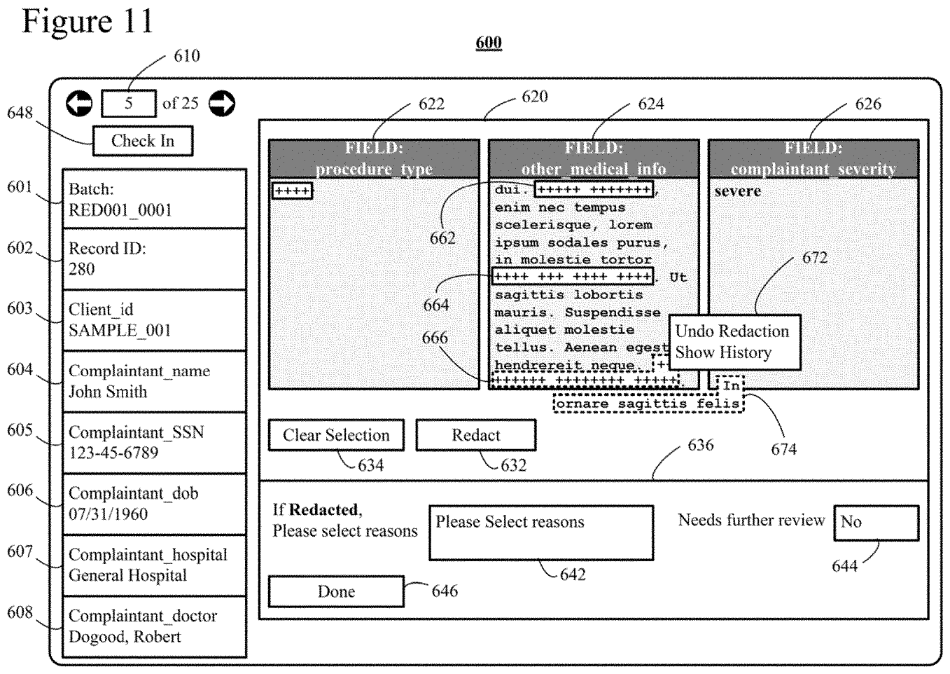

Information about a displayed record of a particular batch of records is displayed in a “Batch” box 601, a “Record ID” box 602, a “Client_id” box 603, a “Complaintant_name” box” 604, a “Complaintant_SSN” box” 605, a “Complaintant_dob” box” 606, a “Complaintant_hospital” box” 607 and a “Complaintant_doctor” box” 608. A display 610 indicated that the displayed record is the fifth of twenty-five (5^{th} of 25) records in this particular batch of records and provides a user means to scroll to both previous and later records. A display box 620 includes a view of three data fields of the record, i.e., a “Field: procedure-type” data field 622, a “Field: other_medical_info” data field 624 and a “Field: complainant_severity” data field 626. It should be understood that the specific information fields 601-608 and data fields 622, 624 and 626 as well as the specific information displayed in each are only used as examples of the information, data fields and data that may be handled in accordance with the disclosed technology. It should also be noted that the character font of the data in fields 622, 624 and 626 has been selected as a “fixed width” font, or “Courier New” in this example. As should be familiar to those with skill in the relevant arts, a “fixed width” font,” also known as “monospaced font” or a “fixed-pitch” font, is a font in which each letter and character occupies the same horizontal space. The significance of the selection of a fixed width font is explained below in conjunction with FIG. 11.

A user may select specific portions of the information in data fields 622, 624 and 626 to redact by directing a cursor (not shown) with mouse 128 (FIG. 1) to highlight the specific portions in a manner that is familiar to those with skill in the relevant arts and clicking on a “Redact” button 632. A “Clear Selection” button 634 enables the user to unselect portions that have been selected for redaction

A display box 636 provides a “Please Select Reason” button 642 to enable a user to enter a reason for a particular redaction, a “Needs Further Review” button 644 to indicate that further review might be necessary and a “Done” button 646 to indicate that the user has finished a review of the particular record in the batch. A “Check in” button 648 enables a user to check in the completed batch in the process associated with User Batch Check In block 416 (FIG. 7). The redaction process and the functionality of window 600 are described in more detail below in conjunction with FIG. 11.

FIG. 11 is an illustration of the Batch Redaction Window 600 of FIG. 10 showing some additional functionality of the claimed subject matter. Like FIG. 10, FIG. 11 includes elements 601-608, 610, 620, 622, 624, 626, 632, 634, 636, 642, 644, 646 and 648, all introduced above in conjunction with FIG. 10. Also illustrated are three portions of the data displayed in data field 624 that a reviewer has highlighted for redaction, specifically a selection 662, a selection 664 and a selection 666. Each character and letter of the actual data within selections 662, 664 and 666 has been obscured in the corresponding selection by being replaced by a “filler” character, i.e., a character in this example. Like the underlying actual characters, the filler characters are rendered in a fixed width font.

When a reviewer positions a cursor (not shown) over a particular selection box, in this example selection box 666, a Undo/Show History popup menu 672 is displayed. Popup menu 672 enables the reviewer to either undo, or remove, the redaction of the selection, i.e., an “un-redaction,” or show a history of the redactions associated with the particular selection. A “Show History” page (not shown) allows the reviewer to see all previous redaction states and to revert to any previous state by clicking on the “Revert to this Version” button (not shown). Reverting to a previous version does not delete any redaction history. Instead, the system creates a new entry in tblRedaction with the selected version's redaction ranges with an updated timestamp and User ID. Clicking a “Back to the Editor” button (not shown) returns the reviewer to the main redaction page 600 without selecting any redaction version. A reviewer can undo any redaction by right-clicking on the redaction. ADPS 114 display a custom context menu (not shown) that allows the reviewer to either undo the redaction or open the Show History page. In addition, a displayed above each redaction field 662, 664 and 666 when a cursor is positioned over the particular field is a hyperlink that allows the reviewer to view the redaction history for that field box, e.g., a display box 674 for field box 666 which shows the reviewer that actual data that has been redacted.

As mentioned above, implementation of the functionality of Window 600 is provided by servers 112 and 122, ADPS 114 and ADPS 134. ADPS 114 employs DB_1 116 (FIG. 1) to store information to implement the functionality; ADPS 134 employs DB_2 136.

Functionality associated with server 122 relies upon two primary tables (not shown) of DB_2 136. i.e., a tblRedaction table and a tblRedactedData table (not shown). tblRedaction table stores a complete history of redactions applied to a given field, which enables ADDS 134 to show redaction history and undo, or “roll back,” redactions to any prior state as initiated by button 672. The data contained in tblRedaction is also used by ADPS 134 to render the redactions on the redaction review form and shown in display area 674.

tblRedaction table stores the following information:
DataID—the field that is redacted
Timestamp—the date and time the field was redacted
Redactions—the set of character ranges redacted for the given field and timestamp. For example, a value of “45-52; 181-242; 594-600;” means that the user redacted characters 45 through 52, 181 through 242 and 594 through 600 in the field.
UserID the user that applied the redactions
tblRedactedData—the current final version of each redacted field in two formats. One version (“RedactedText”) replaces the redacted range with “[Redacted].” The other version (“RedactedTextRTF”) replaces each character in the redacted range with the redaction replacement character (by default, the “+” character) and applies RTF formatting to highlight the redacted text in black. For example, if the word “This” in “This sentence is redacted,” was redacted, the system would store “[Redacted] sentence is redacted.” in the RedactedText field and “{\rtf1\ansi\deff0 {\colortbl;\red0\green0\blue0;red255\green255\blue255;}\cf2\highlight1++++\cf0\highlight0} sentence is redacted.” in the RedactedTextRTF field. When rendered by an RTF-compliant viewer the RedactedTextField would look like this: “++++ sentence is redacted.”The setting for the redaction replacement character is configurable by project. It is stored in the DB_2 131 in a tblProjectSetting table.

A summary of redaction status by record (Redactions Applied and Redactions Complete) is stored in a tblRecordCodingProperties table of DB_2 136. When generating data for display in window 600, ADPS 134 collects the relevant data in a model called RedactViewModel and passes it to window 600 for rendering. RedactViewModel is a collection of other models, lists and single-value fields. Below is a tree that summarizes the data contained in Redact View Model:
RedactViewModel
BatchData—Information about the batch
BatchId
BatchName
BatchType
Breadcrumb—Used as navigation aid within app
CodingPaletteData—Information about the coding palette type for this batch
Is Success—Did server return data successfully
Message—Used to pass error messages to the web app
ProjectId
ProjectName
Redact Data
RecordId
RedactionFields—Value of the fields to be displayed in the redaction panel (includes redaction fields plus non-redactable large text fields)
RedactHistoryList—Contains redaction history data
RedactionHistory Model
RedactedTextList—start/end ranges of redacted text
RedactRecord—List of records in review batch
BatchId
CurrentIndex—Position within batch
RecordId
Status—Review status
RelatedData
RecordId
RelatedFields—non-redactable fields that are chosen by the system administrator for display to provide additional context to the reviewer
ResponsiveList—List of records marked as Responsive within the batch
SettingData
RedactSettingText—gets the redaction replacement character, e.g., “+”
RedactSettingColor—gets the redaction highlight color, e.g., “yellow”

Functionality associated with client system 102 and ADPS 114 include when a reviewer opens a web page that contains redacted fields. ADPS 114 requests redaction data from the server 122 and ADPS 134. Server 122 returns the relevant redaction data to the web page via a RedactViewModel (not shown). RedactViewModel data is displayed on the screen in panels 622, 624 and 626. Panel 622 contains the “Related Fields,” or fields selected for display by the system administrator to assist the reviewer in determining responsiveness, privilege or the need for redactions.

The bottom panel 636 is the coding palette. The system currently has two coding palettes for records to redact one for redaction-only review and one for a combination redaction/relevance review. The redaction-only coding palette contains a single picklist 642 of redaction reasons, e.g., PII or Trade Secret. The combination coding palette includes fields for responsiveness, privilege and privilege reason (if the record is marked privileged).

Panel 624 contains fields to redact plus large text fields over character limit specified in the project settings (default is 150). The redaction fields are identified by a “Field complete” checkbox (not shown) plus a Show History hyperlink (see 672, FIG. 11. Related fields are identified by a “Related info, not redactable” label (not shown).

When loading redaction screen 600. ADPS 114 renders the redaction fields without any redactions and then via JavaScript dynamically applies the redactions to the redaction fields. For each redaction the system tracks the starting and ending character range, which is delivered to the web page within the RedactViewModel. The JavaScript scripts then find each range within the source data, replace each non-whitespace character with the redaction replacement character and wrap the range with a custom <span> tag that highlights the range with a configurable redaction highlight color. Finally, the scripts update the tool tip for each span to show the unredacted original text by hovering over the redaction.

The redaction process begins when the reviewer selects a new range of text to redact. The system captures the selection and identifies the character range selected. In the case of overlapping ranges (where the user's selection overlaps with an existing redaction range the system identifies the overlaps and removes them from the user's selection.

In the background, and in anticipation of the user clicking the Redact button, the system iterates through the remaining ranges and replaces all non-whitespace characters with the redaction replacement text. Next, the system adds the newly-selected ranges to the set of existing ranges and sorts the list, combining any adjoining ranges. Finally, the system wraps each range in the final set with a custom <span> tag to highlight the selection.

The redaction process completes when the reviewer selects Redact button 632. ADPS 114 packages the record ID, the field ID of the data being redacted, and the redaction ranges for each redacted field and passes the data back to the ADPS 134. ADPS 134 first updates tblRedaction with the following information:
DataID—ID of the field/data element being redacted
Timestamp
Redactions—a semicolon-delimited list of redaction ranges
UserID—the ID of the reviewer who clicked the Redact button

Next, ADPS 134 sets the Redaction Applied field in tblRecordCodingProperties to True. Finally, ADPS 134 creates two versions of redacted text to store in tblRedactedData, i.e., a version that replaces every redaction with “[Redacted]” and a version using RTF markup that replaces each redacted non-whitespace character with the redaction replacement text and highlights each redaction in black.

While the claimed subject matter has been shown and described with reference to particular embodiments thereof, it will be understood by those skilled in the art that the foregoing and other changes in form and detail may be made therein without departing from the spirit and scope of the claimed subject matter, including but not limited to additional, less or modified elements and/or additional, less or modified blocks performed in the same or a different order.

We claim:

1. A method for the processing and production of electronically stored information (ESI), comprising:
receiving ESI in response to a judicial production request;
parsing the ESI to identify a plurality of data fields within the ESI;
identifying for redaction a first data field of the plurality of data fields;
storing in a non-transitory computer readable storage medium information in the first data field;
replacing the information in the first data field with a plurality of filler characters such that each character of the information is replaced by a corresponding filler character; and
producing the data such that the first data field is displayed as the corresponding filler characters wherein the displayed filler characters use the same line space as the would the information if the information was displayed.

2. The method of claim 1, further comprising:
selecting the first data filed for un-redaction; and
in response to the selecting for un-redaction, replacing the corresponding filler characters in the first data field with the corresponding stored information.

3. The method of claim 1, wherein the plurality of filler characters are a fixed width font.

4. The method of claim 1, further comprising:
identifying a second data field of the plurality of data fields subject to redaction;
storing in a non-transitory computer readable storage medium information in the second data field;
replacing the information in the second data field with a plurality of filler characters such that each character of the information is replaced by a corresponding filler character;
selecting the second data field for un-redaction; and
producing the data such that the first data field is displayed as the filler characters and the second data field is displayed with the original information.

5. The method of claim 1, further comprising maintaining a redaction history record, the redaction history record consisting of a selection of data elements from a list, the list comprising:
information on requested redactions;
information on requested un-redactions,
a reason for each particular redaction; and
a party implementing each redaction and un-redaction.

6. The method of claim 1, wherein the ESI is stored in two or more differently structured databases, further comprising normalizing the structure of the two or more differently structured databases.

7. The method of claim 1, the producing the data comprising proving the data into a format suitable for attorney review with respect to a judicial production request.

8. An apparatus for the processing and production of electronically stored information (ESI), comprising:
a processor;
a non-transitory computer-readable storage medium; and
program code, stored on the non-transitory computer-readable storage medium and executed on the processor, for executing a method, the method comprising:
receiving ESI in response to a judicial production request;
parsing the ESI to identify a plurality of data fields within the ESI;
identifying for redaction a first data field of the plurality of data fields;
storing in a non-transitory computer readable storage medium information in the first data field;
replacing the information in the first data field with a plurality of filler characters such that each character of the information is replaced by a corresponding filler character; and
producing the data such that the first data field is displayed as the corresponding filler characters wherein the displayed filler characters use the same line space as the would the information if the information was displayed.

9. The apparatus of claim 8, the method further comprising:
selecting the first data filed for un-redaction; and
in response to the selecting for un-redaction, replacing the corresponding filler characters in the first data field with the corresponding stored information.

10. The apparatus of claim 8, wherein the plurality of filler characters are a fixed width font.

11. The apparatus of claim 8, the method further comprising:
identifying a second data field of the plurality of data fields subject to redaction;
storing in a non-transitory computer readable storage medium information in the second data field;
replacing the information in the second data field with a plurality of filler characters such that each character of the information is replaced by a corresponding filler character;
selecting the second data field for un-redaction; and
producing the data such that the first data field is displayed as the filler characters and the second data filed is displayed with the original information.

12. The apparatus of claim 8, the method further comprising maintaining a redaction history record, the redaction history record consisting of a selection of data elements front a list, the list comprising:
information on requested redactions;
information on requested un-redactions,
a reason for each particular redaction; and
a party implementing each redaction and un-redaction.

13. The apparatus of claim 8, wherein the ESI is stored in two or more differently structured databases, further comprising normalizing the structure of the two or more differently structured databases.

14. The apparatus of claim 8, the producing the data comprising proving the data into a format suitable for attorney review with respect to a judicial production request.

15. A computer programming product for the processing and production of electronically stored information (ESI), comprising a non-transitory computer-readable storage medium having program code embodied therewith, the program code executable by a plurality of processors to perform a method comprising:
receiving ESI in response to a judicial production request;
parsing the ESI to identity u plurality of data fields within the ESI;
identifying for redaction a first data field of the plurality of data fields;
storing in a non-transitory computer readable storage medium information in the first data field;
replacing the information in the first data field with a plurality of filler characters such that each character of the information is replaced by a corresponding filler character; and
producing the data such that the first data field is displayed as the corresponding filler characters wherein the displayed filler characters use the same line space as the would the information if the information was displayed.

16. The computer programming product of claim 15, the method further comprising:
selecting the first data filed for un-redaction; and
in response to the selecting for un-redaction, replacing the corresponding filler characters in the first data field with the corresponding stored information.

17. The computer programming product of claim 15, wherein the plurality of filler characters are a fixed width font.

18. The computer programming product of claim 15, the method further comprising:
identifying a second data field of the plurality of data fields subject to redaction;
storing in a non-transitory computer readable storage medium information in the second data field;
replacing the information in the second data field with a plurality of filler characters such that each character of the information is replaced by a corresponding filler character;
selecting the second data field for un-redaction; and
producing the data such that the first data field is displayed as the filler characters and the second data filed is displayed with the original information.

19. The computer programming product of claim 15, the method further comprising maintaining a redaction history record, the redaction history record consisting of a selection of data elements from a list, the list comprising:
information on requested redactions;
information on requested un-redactions,
a reason for each particular redaction; and
a party implementing each redaction and un-redaction.

20. The computer programming product of claim 15, wherein the ESI is stored in two or more differently structured databases, further comprising normalizing the structure of the two or more differently structured databases.
